(19) United States
(12) Patent Application Publication
(10) Pub. No.: US 2023/0271688 A1
(43) Pub. Date: Aug. 31, 2023

(54) OUTBOARD MOTOR AND VESSEL

(71) Applicant: Honda Motor Co., Ltd., Tokyo (JP)

(72) Inventors: Yoshihiro Harada, Wako-shi (JP); Tsuyoshi Yoshigasaki, Wako-shi (JP); Shigekazu Sakata, Wako-shi (JP); Mao Horiguchi, Wako-shi (JP); Hiroshi Yamamoto, Wako-shi (JP); Ryo Kawahata, Wako-shi (JP)

(21) Appl. No.: 18/112,456

(22) Filed: Feb. 21, 2023

(30) Foreign Application Priority Data
Feb. 28, 2022 (JP) 2022-029019

(51) Int. Cl. B63H 20/32; F16B 2/06

(52) U.S. Cl. CPC B63H 20/32; F16B 2/06

(57) ABSTRACT

An outboard motor, includes: an engine; and an accommodation cover forming an accommodation space accommodating the engine. The accommodation cover includes: a lower cover configured to accommodate a lower part of the engine; an upper cover attached to the lower cover and configured to accommodate an upper part of the engine; and a plurality of lock portions provided in a connection part between the lower cover and the upper cover facing the accommodation space and configured to fix the upper cover to the lower cover. A part of the plurality of lock portions includes an interlocking mechanism configured to lock or unlock the part of the plurality of lock portions simultaneously in response to a single operation.

### CROSS-REFERENCE TO RELATED APPLICATION

This application is based upon and claims the benefit of priority from Japanese Patent Application No. 2022-029019 filed on Feb. 28, 2022, the content of which is incorporated herein by reference.

### BACKGROUND OF THE INVENTION

### Field of the Invention

This invention relates to an outboard motor and a vessel including the outboard motor.

### Description of the Related Art

Conventionally, a cover that accommodates an engine of an outboard motor includes an under cover that supports the engine from below and an engine cover that is supported by the under cover and covers the engine from above, for easy maintenance and adjustment. As a lock portion for fixing such a divisible engine cover and an under cover, a lever type lock portion is known (see, for example, JP 2007-296999 A).

However, since the lever type lock portion described in JP 2007-296999 A is provided to be exposed to the outside of the cover, the lever type lock portion affects the appearance of the outboard motor, and there is also a risk of breakage or the like due to contact.

### SUMMARY OF THE INVENTION

An aspect of the present invention is an outboard motor, including: an engine; and an accommodation cover forming an accommodation space accommodating the engine. The accommodation cover includes: a lower cover configured to accommodate a lower part of the engine; an upper cover attached to the lower cover and configured to accommodate an upper part of the engine; and a plurality of lock portions provided in a connection part between the lower cover and the upper cover facing the accommodation space and configured to fix the upper cover to the lower cover. A part of the plurality of lock portions includes an interlocking mechanism configured to lock or unlock the part of the plurality of lock portions simultaneously in response to a single operation.

Another aspect of the present invention is a vessel, including: an outboard motor; and a hull to which the outboard motor is attached.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating a vessel equipped with an outboard motor according to an embodiment of the present invention;

FIG. 2 is a side view schematically illustrating configuration of a main part of the outboard motor according to the embodiment of the present invention;

FIG. 3 is a perspective view illustrating a plurality of lock portions provided in a connection part between an upper cover and a lower cover facing an accommodation space of an accommodation cover;

FIG. 4A is a side view of a first lock portion;

FIG. 4B is a front view of the first lock portion;

FIG. 5 is a side view illustrating a lock state and an unlock state of the first lock portion and a second lock portion interlocked by an interlocking mechanism; and

FIG. 6 is a front view illustrating an operation part of the first lock portion operated with a tool inserted through an opening provided in the lower cover.

### DETAILED DESCRIPTION OF THE INVENTION

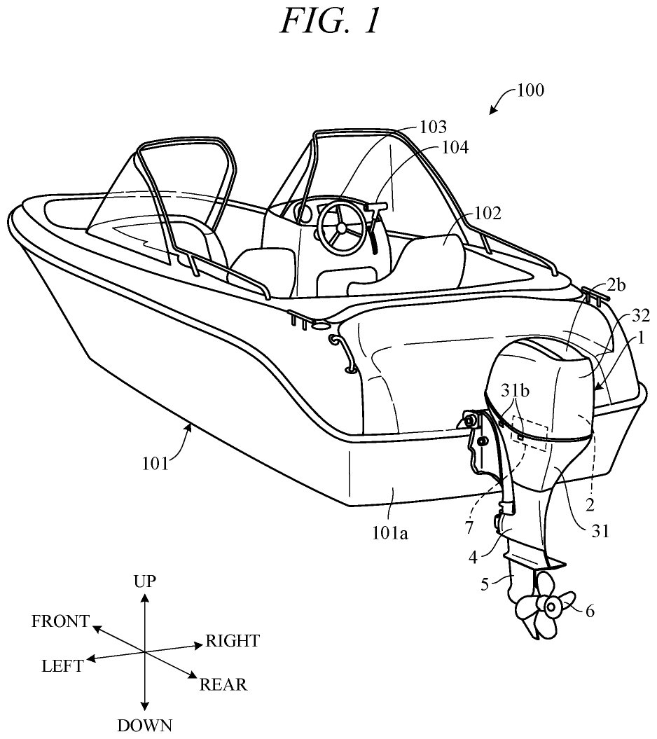

Hereinafter, an embodiment of the present invention will be described with reference to FIGS. 1 to 6. FIG. 1 is a perspective view schematically illustrating a vessel 100 equipped with an outboard motor 1 according to an embodiment of the present invention. Hereinafter, a front-rear direction (propulsion direction), a right-left direction, and an up-down direction are defined as illustrated in the drawing, and each unit will be described according to the definition. As illustrated in FIG. 1, the outboard motor 1 is attached to the stern of a hull 101 of the vessel 100, and is driven in response to the operation of a vessel operator to propel the hull 101. A steering wheel 103 and a shift lever (shift/throttle lever) 104 are provided near a cockpit 102 of the hull 101. A shift lever 104 is configured to be swingable in the forward direction or the rearward direction from the neutral position, and inputs a switching instruction from the neutral direction to the forward or rearward direction and an adjustment instruction of the engine rotation speed in response to the operation of the vessel operator.

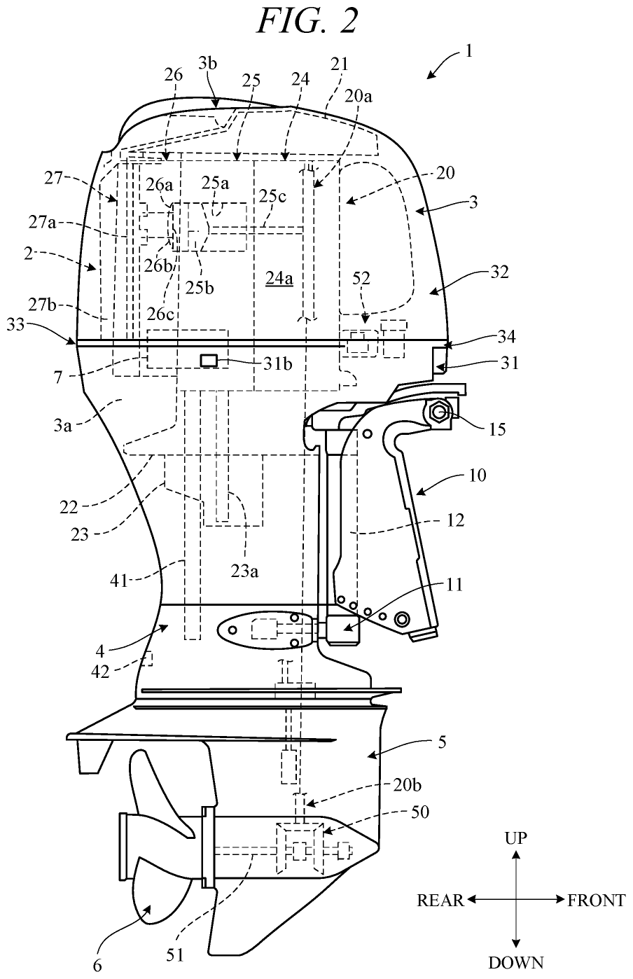

FIG. 2 is a side view schematically illustrating the configuration of a main part of the outboard motor 1. As illustrated in FIG. 2, the outboard motor 1 is attached to a transom board 101a (FIG. 1) positioned at the stern of the hull 101 via a stern bracket 10 provided in front. A swivel case 11 is provided behind the stern bracket 10, and a swivel shaft 12 rotatable about a vertical axis is accommodated in the swivel case 11. The swivel shaft 12 constitutes a turning shaft that steers the hull 101 to right and left.

Both right and left sides of the stern bracket 10 are provided with power tilt units (not illustrated) for tilting up and tilting down or trimming up and trimming down the outboard motor 1. The power tilt unit includes a tilt angle adjustment hydraulic cylinder and a trim angle adjustment hydraulic cylinder, and the swivel case 11 pivots with a tilting shaft as a rotation axis by extending and contracting these hydraulic cylinders. This makes the outboard motor 1 tilted up and tilted down or trimmed up and trimmed down.

The outboard motor 1 includes an engine 2, an accommodation cover 3 forming an accommodation space 3a for accommodating the engine 2, an extension case 4 connected to a lower end part of the accommodation cover 3, a gear case 5 connected to a lower end part of the extension case 4, and a propeller 6 rotating by power of the engine 2. The accommodation space 3a of the accommodation cover 3 and an internal space of the extension case 4 communicate with each other. The internal space of the extension case 4 and an internal space of the gear 5 case communicate with each other. The lower end part of the accommodation cover 3 and an upper end part of the extension case 4 are integrally connected so as to be in a water stop state. The lower end part of the extension case 4 and an upper end part of the gear case 5 are integrally connected so as to be in a water stop state.

The engine 2 is configured as a V type multi-cylinder engine in which a pair of banks (cylinder rows) formed by arranging a plurality of cylinders 25a in the up-down direction are arranged in a V shape. For example, the engine 2 is configured as a V type six-cylinder engine including three cylinders in each bank. The engine 2 includes an engine body 20, an intake device 21 provided in an upper part of the engine body 20, a mount case 22 provided in a lower part of the engine body 20, and an oil pan 23 provided in a lower part of the mount case 22. The engine body 20 is accommodated in the accommodation cover 3 via the mount case 22 disposed in the accommodation space 3a in a state where a crankshaft 20a extends in the vertical direction.

The engine body 20 includes a crankcase 24 that accommodates the crankshaft 20a extending in the vertical direction, a cylinder block 25 that is attached to the crankcase 24 and in which the cylinder 25a is formed, a cylinder head 26 that is attached to the cylinder block 25 and provided with an intake port 26a and an exhaust port 26b communicating with the cylinder 25a, and a cylinder head cover 27 that covers the cylinder head 26.

The crankcase 24 and the cylinder block 25 constitute a crank chamber 24a, and the crankshaft 20a is accommodated in the crank chamber 24a. The lower end of the crankshaft 20a extends downward from the crank chamber 24a and is connected to a drive shaft 20b described below. The upper end of the crankshaft 20a extends upward from the crank chamber 24a, and a crank pulley (not illustrated) is attached to an extension part thereof.

In the cylinder block 25, the plurality of cylinders 25a arranged in the up-down direction are formed in each bank. FIG. 2 illustrates only one cylinder 25a for convenience. The cylinder 25a slidably accommodates a piston 25b, and one end of a connecting rod 25c is coupled to the piston 25b. The other end of the connecting rod 25c is coupled to the crankshaft 20a, and the piston 25b slides in the cylinder 25a, whereby the crankshaft 20a rotates.

The cylinder block 25 and the cylinder head 26 constitute a combustion chamber 26c for each cylinder 25a, and the intake port 26a and the exhaust port 26b communicate with each combustion chamber 26c. The intake port 26a and the exhaust port 26b are provided with an intake valve and an exhaust valve (not illustrated). A camshaft 27a extending in the vertical direction is rotatably supported on the rear side of the cylinder head 26, and the intake valve and the exhaust valve are driven by the rotation of the camshaft 27a, and the intake port 26a and the exhaust port 26b are opened and closed.

The cylinder head 26 and the cylinder head cover 27 constitute a cam chamber 27b that accommodates the camshaft 27a. An upper end of the camshaft 27a extends upward from the cam chamber 27b, and a cam pulley (not illustrated) is attached to the extension part thereof. A timing belt (not illustrated) is wound around the cam pulley and the crank pulley, and when the crankshaft 20a rotates, the camshaft 27a also rotates via the timing belt.

The intake device 21 guides the air introduced from an air introduction unit 3b formed in the accommodation cover 3 to the intake port 26a of the combustion chamber 26c of each of the plurality of cylinders 25a formed in each bank. The mount case 22 is interposed between the engine body 20 and the oil pan 23 and supports the engine body 20. The oil pan 23 stores oil for lubricating the inside of the engine body 20. The oil stored in the oil pan 23 is pumped up by an oil pump 23a, passes through an oil path (not illustrated) formed in the mount case 22, the cylinder block 25, and the cylinder head 26, and is supplied to bearing parts of the crankshaft 20a and the camshaft 27a and the like.

The lower end of the crankshaft 20a is incorporated in a lower cover 31 described below and the extension case 4, and is connected to the upper end of the drive shaft 20b extending in the vertical direction. The lower end of the drive shaft 20b is connected to one end of a propeller shaft 51 extending in the horizontal direction via a gear mechanism 50 incorporated in the gear case 5. The propeller 6 is attached to the other end of the propeller shaft 51. The propeller shaft 51 is disposed such that the axis of the propeller shaft 51 becomes substantially parallel to the horizontal (front-rear direction) when the trim angle is in an initial angle state.

Exhaust gas discharged from the engine 2 is guided to the inside of the extension case 4 through an exhaust passage 41. The exhaust gas guided to the inside of the extension case 4 through the exhaust passage 41 is discharged to the outside of the extension case 4 through a discharge port 42 bored in the extension case 4 or through a boss portion of the gear case and the propeller shaft 51.

The gear case incorporates the gear mechanism 50. A shift device (shift actuator) 52 that performs shift change by operating the gear mechanism 50 is connected to the gear mechanism 50. A shift device 52 is disposed near a connection part 33 on the starboard front side of the lower cover 31 and an upper cover 32. The shift device 52 is electrically connected to the shift lever 104, and when the shift device 52 is driven in response to the operation of the shift lever 104 by the vessel operator, the gear mechanism 50 is switched among the neutral position, the forward position, and the rearward position. When the gear mechanism 50 is in the forward or rearward position, the rotation of the drive shaft 20b is transmitted to the propeller shaft 51 via the gear mechanism 50 and the propeller 6 rotates, thereby propelling the hull 101 in the forward direction or the rearward direction.

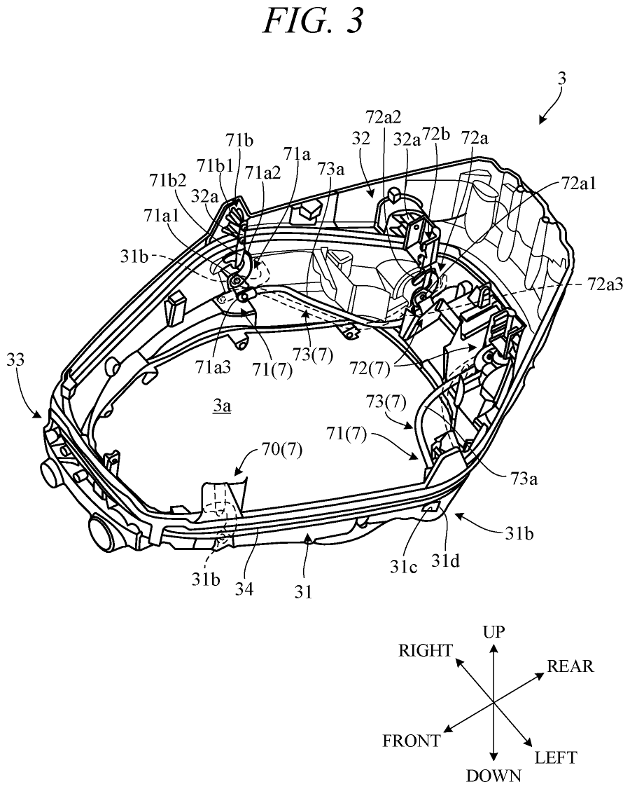

The accommodation cover 3 includes the lower cover 31 that accommodates a lower part of the engine 2, the upper cover 32 that is removably attached to the lower cover 31 and accommodates the engine 2 so as to cover the upper part of the engine 2, and a plurality of (five in FIG. 3) lock portions 7 that are provided in the connection part 33 between the lower cover 31 and the upper cover 32 facing the accommodation space 3a in the accommodation cover 3, and fix the upper cover 32 to the lower cover 31. The accommodation space 3a in the accommodation cover 3 is formed by attaching the upper cover 32 to the lower cover 31. That is, the accommodation space 3a is constituted by an internal space defined by the lower cover 31 and the upper cover 32.

The lower cover 31 is formed in a shape in which the upper end part and the lower end part are opened, and is formed such that the opening at the lower end part becomes smaller than the opening at the upper end part. The upper end part is formed to allow the upper cover 32 to be attached via a seal member 34, and the lower end part is formed to allow the upper end part of the extension case 4 to be integrally connected. In the accommodation space 3a on the lower cover 31 side, a lower part of the engine body supported by the mount case 22, the mount case 22, the oil pan 23, and the like are mainly disposed, and the mount case 22 is fixed to an inner surface of the lower cover 31.

The upper cover 32 is formed in a bag shape in which a lower end part is opened and an upper end part is closed, and the lower end part is formed to be attachable to the upper end part of the lower cover 31 via the seal member 34. In the accommodation space 3a on the upper cover 32 side, an upper part of the engine body 20 supported by the lower cover 31, the intake device 21, and the like are mainly disposed.

As the lock portion for fixing the upper cover 32 to the lower cover 31, a lever type lock portion for fixing the upper cover 32 to the lower cover 31 by pulling up or pulling down a lever is sometimes used. However, since the lever type lock portion is provided to be exposed to the outside of the accommodation cover 3, the lever type lock portion easily affects the appearance design of the accommodation cover 3, and there is also a risk of breakage or the like due to contact.

On the other hand, the lock portion is provided inside the accommodation cover 3 and can be approached from the outside, whereby the exposed part of the lock portion can be reduced. However, since the outboard motor 1 needs to firmly retain the lock state of the upper cover 32, it is necessary to provide a plurality of lock portions. Providing the plurality of lock portions increases man-hours for attaching and removing the upper cover 32 at the time of maintenance or adjustment of the engine 2, which is complicated for the user.

Therefore, in the present embodiment, the plurality of lock portions are provided inside the accommodation cover 3, and an interlocking mechanism that simultaneously locks the plurality of lock portions with a single lock operation is provided. This makes it possible to attach and remove the upper cover 32 without increasing the number of man-hours, and it is also possible to suppress the influence on the appearance design of the outboard motor 1 and the possibility of breakage. Details of such the outboard motor 1 will be described below.

FIG. 3 is a perspective view illustrating the plurality of lock portions 7 provided in the connection part 33 between the upper cover 32 and the lower cover 31 facing the accommodation space 3a of the accommodation cover 3. For the purpose of description of the plurality of lock portions 7, FIG. 3 only illustrates the periphery of the connection part 33 with the upper part of the upper cover 32 and the lower part of the lower cover 31 being cut out.

As illustrated in FIG. 3, the plurality of lock portions 7 include an independent lock portion 70 that is independently locked or unlocked, and a first lock portion 71 and a second lock portion 72 that are interlockably coupled by an interlocking mechanism 73 and are simultaneously locked or unlocked in conjunction with a single lock operation or unlock operation. The first lock portion 71 and the second lock portion 72 are simultaneously locked or unlocked in conjunction with a single lock operation or unlock operation on the first lock portion 71. The first lock portion 71 and the second lock portion 72 coupled by the interlocking mechanism 73 are configured as the pair of adjacent lock portions 7. The first lock portion 71 is disposed on the front side relative to the second lock portion 72.

The first lock portion 71 and the second lock portion 72 are not limited to the pair of adjacent lock portions 7. Three or more lock portions 7 may be configured to be interlockable. In this case, the lock portion positioned at the forefront is preferably the first lock portion 71 to be subjected to the lock operation and the unlock operation. The first lock portion 71 and the second lock portion 72 may be non-adjacent lock portions 7.

The independent lock portion 70 is disposed on the port front side. The first lock portion 71 and the second lock portion 72 include the first lock portion 71 and the second lock portion 72 disposed on the port rear side and coupled by the interlocking mechanism 73, and the first lock portion 71 and the second lock portion 72 disposed on the starboard rear side and coupled by the interlocking mechanism 73.

By providing the first lock portion 71 and the second lock portion 72 on each of the port rear side and the starboard rear side, the number of the lock portions 7 becomes larger on the rear side than on the front side, and for example, even when a load larger than that on the front side is generated on the rear side of the accommodation cover 3 when the outboard motor 1 is tilted up, it is possible to prevent the upper cover 32 from being removed from the lower cover 31 or a gap or the like from being generated in the connection part 33. Since the load generated on the rear side at the time of tilting up is dispersed by the first lock portion 71 and the second lock portion 72 on the port rear side and the starboard rear side, the product life of the lock portion 7 can be extended.

Furthermore, by disposing not only the first lock portion 71 and the second lock portion 72 disposed each on the port rear side and the starboard rear side but also the independent lock portion 70 on the port front side, it is possible to shorten the distance along the connection part 33 of the front side part where the lock portion 7 is not disposed, and therefore it is possible to prevent generation of a gap or the like in the connection part 33 on the front side. That is, by disposing the independent lock portion 70 at a place where the length along the connection part 33 where the first lock portion 71 and the second lock portion 72 are not disposed is relatively long, it is possible to appropriately disperse the load generated in the connection part 33.

In the examples of FIGS. 2 and 3, the independent lock portion 70 is disposed only on the port front side in order to avoid the shift device 52 disposed on the starboard front side near the connection part 33. However, when there is a space on the starboard front side, the independent lock portion 70 may be disposed only on the starboard front side, or the independent lock portions 70 may be disposed on the starboard front side and the port front side. When the independent lock portions 70 are disposed on both the starboard front side and the port front side, they may be coupled by the interlocking mechanism 73.

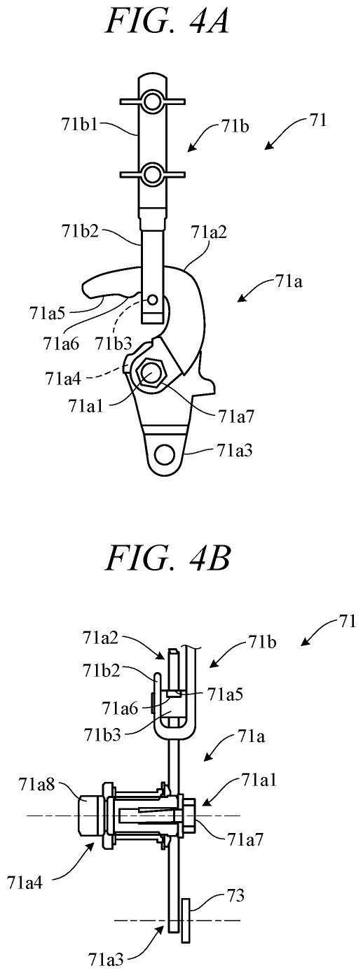

Next, the configuration of the individual lock portions 7 will be described. The independent lock portion 70, the first lock portion 71, and the second lock portion 72 have the same configuration, and thus will be described using the first lock portion 71. FIG. 4A is a side view of the first lock portion 71, and FIG. 4B is a front view of the first lock portion 71.

As illustrated in FIGS. 4A and 4B, the first lock portion 71 includes an engaging part 71a and an engaged part 71b configured to be engageable. The engaging part 71a is attached to the inner surface side of the lower cover 31 near the connection part 33, and is configured to be engageable with or disengageable from the engaged part 71b in response to the pivot operation. The engaged part 71b is configured to be lighter in weight than the engaging part 71a, and is fixed to the inner surface side of the upper cover 32 near the connection part 33. By attaching the engaged part 71b lighter in weight than the engaging part 71a to the upper cover 32, it is possible to reduce the weight of the upper cover 32 as compared with that in the case where the engaging part 71a is attached to the upper cover 32.

The engaging part 71a has an elongated shape centered on a pivot shaft part 71a1, and includes a substantially L shaped hook part 71a2 provided on one side in the long direction, a couple part 71a3 provided on the other side, and an operation part 71a4 provided coaxially with the pivot shaft part 71a1. The engaging part 71a is provided facing the accommodation space 3a such that the axial direction of the pivot shaft part 71a1 becomes substantially parallel to the direction penetrating the lower cover 31.

The hook part 71a2 has a lock convex part 71a6 that can be locked to the engaged part 71b on an engagement surface 71a5 to be engaged with the engaged part 71b. When the engagement surface 71a5 of the hook part 71a2 is engaged with the engaged part 71b, when the lock convex part 71a6 of the engagement surface 71a5 is locked to the engaged part 71b, the engaging part 71a is fixed to the engaged part 71b in a state of being engaged with the engaged part 71b (lock state). The interlocking mechanism 73 is pivotally coupled to the couple part 71a3 positioned on the opposite side of the hook part 71a2.

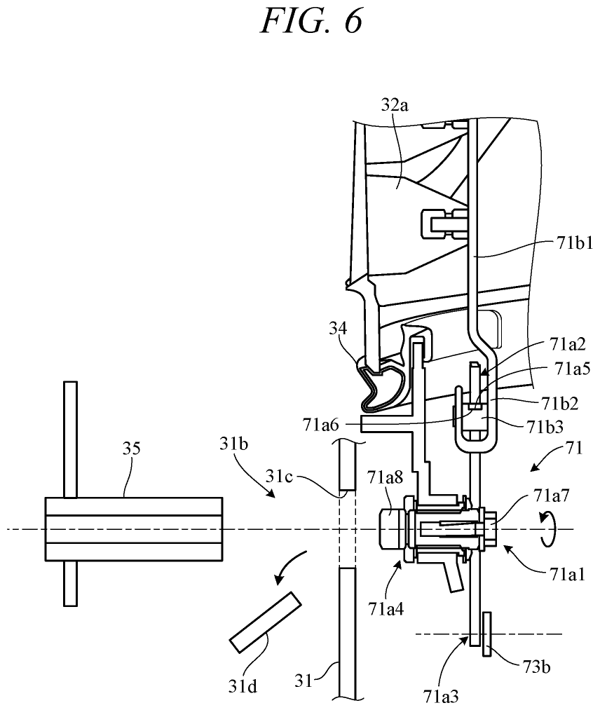

The operation part 71a4 is fixed to the pivot shaft part 71a1 coaxially with the pivot shaft part 71a1, and is configured such that the hook part 71a2 and the couple part 71a3 integrally pivot by rotating the operation part 71a4. The operation part 71a4 is fixed to the pivot shaft part 71a1 by a bolt 71a7 coaxially screwed. The operation part 71a4 is fixed to the pivot shaft part 71a1 so as to protrude toward the inner surface of the lower cover 31, and its tip end part is provided with a fit part 71a8 that can be fitted with a tool 35 (box wrench in the example of FIG. 6). For example, when the tool 35 equipped on the vessel 100 is a hexagonal wrench, the fit part 71a8 is formed in a hexagonal nut shape.

The operation part 71a4 is supported by the lower cover 31 so as to rotate in accordance with the applied rotational torque when applied with a predetermined or greater rotational torque. For example, the operation part 71a4 is supported by the lower cover 31 so as to rotate only when the user uses the tool 35 to apply a predetermined or greater rotational torque to the operation part 71a4. By causing the lower cover 31 to support the operation part 71a4 such that the operation part 71a4 rotates only when a predetermined or greater rotational torque is applied to the operation part 71a4, the engaging part 71a is prevented from unnecessarily pivoting, and locking and unlocking can be performed only when necessary.

The configurations of the independent lock portion 70, the first lock portion 71, and the second lock portion 72 are not limited to the same configuration. For example, since the second lock portion 72 is interlocked with the first lock portion 71, the second lock portion 72 may have a configuration without the operation part 71a4. When the second lock portion 72 does not have the operation part 71a4, the weight of the second lock portion 72 can be reduced. When the independent lock portion 70, the first lock portion 71, and the second lock portion 72 have the same configuration, versatility of the lock portion 7 can be enhanced.

The engaged part 71b includes an attachment part 71b1 attached to the upper cover 32 and a U shaped part 71b2 formed in a substantially U shape. The engaged part 71b is fixed at an appropriate position of the upper cover 32 by the attachment part 71b1 via a boss part 32a (FIG. 3) provided on the upper cover 32. The U shaped part 71b2 has, on the inner side thereof, a rod shaped part 71b3 arranged to be engaged with the engagement surface 71a5 of the hook part 71a2 and to be capable of locking the lock convex part 71a6. By adjusting the position of the rod shaped part 71b3 in the up-down direction, it is possible to adjust the engagement or locking strength in the engaged state or the locked state with the engaging part 71a.

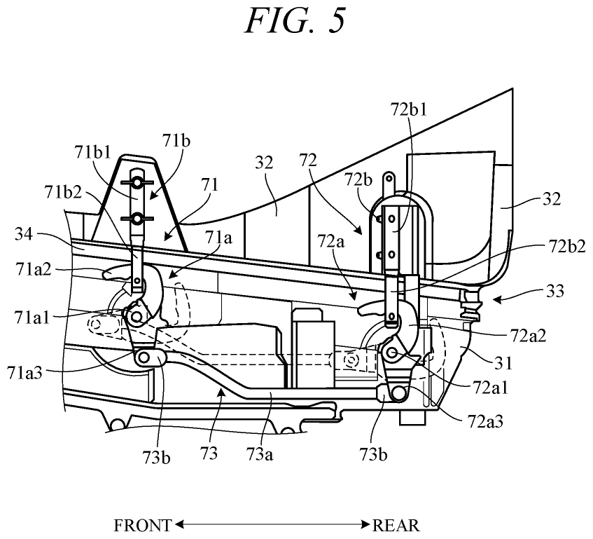

FIG. 5 is a side view illustrating a lock state and an unlock state of the first lock portion 71 and the second lock portion 72 interlocked by the interlocking mechanism 73. In FIG. 5, the solid line indicates the lock state, and the broken line indicates the unlock state.

As illustrated in FIG. 5, the interlocking mechanism 73 includes a transmission arm 73a that transmits a lock operation and an unlock operation on the operation part 71a4 (FIGS. 4A and 4B) of the first lock portion 71 to the second lock portion 72, and pivot couple parts 73b that are provided at both ends of the transmission arm 73a and are pivotally coupled to the couple parts 71a3 and 72a3 of the first lock portion 71 and the second lock portion 72, respectively.

The transmission arm 73a transmits the pivot operation of the engaging part 71a of the first lock portion 71 to the engaging part 72a of the second lock portion 72, and causes the engaging part 72a of the second lock portion 72 to perform the pivot operation similar to that of the engaging part 71a of the first lock portion 71. The engaging part 71a of the first lock portion 71, the engaging part 72a of the second lock portion 72, and the interlocking mechanism 73 constitute a link mechanism to interlock the engaging parts 71a and 72a together.

The transmission arm 73a is formed in a rod shape, and is provided along the inner surface and an unevenness provided on the inner surface of the lower cover 31 while avoiding the unevenness. That is, the transmission arm 73a has a curved shape so as to be able to be along the inner surface and the unevenness. By forming the transmission arm 73a in a curved shape along the inner surface and the unevenness, it is possible to reduce the operation space of the transmission arm 73a and to make it difficult to interfere with the engine 2 to be accommodated.

FIG. 6 is a front view illustrating the operation part 71a4 of the first lock portion 71 operated (lock operation and unlock operation) by the tool 35 inserted through an opening 31c provided in the lower cover 31.

As illustrated in FIG. 6, the upper end part (near the connection part 33) of the lower cover 31 is provided with an opening/closing part 31b at a position opposing the operation part 71a4 of the first lock portion 71. The opening/closing part 31b is provided only at a position opposing the operation part 71a4 of the first lock portion 71, and is not provided at a position opposing the operation portion 72a4 of the second lock portion 72. By providing the opening/closing part 31b only at a position opposing the operation part 71a4 of the first lock portion 71, it is possible to reduce the influence on the appearance design of the lower cover 31. In particular, since the first lock portion 71 is provided on the front side of the second lock portion 72, it is possible to reduce the influence on the appearance design of the rear side of the accommodation cover 3.

The opening/closing part 31b is also provided at a position opposing the operation part 70a4 of the independent lock portion 70, but since the independent lock portion 70 is also provided on the front side, there is little influence on the appearance design of the rear side of the accommodation cover 3.

The opening/closing part 31b includes the opening 31c formed in a size into which a tool 35 for operating the operation part 71a4 of the first lock portion 71 can be inserted, and a lid 31d configured to be able to open and close the opening 31c. The lid 31d is configured to seal the opening 31c, to pivot such that an upper part of the opening 31c protrudes, for example, when a lower part of the lid 31d is pressed, and to be removable from the opening 31c when the protruding upper part is pinched and pulled. The lid 31d has a couple part not illustrated, and is configured to be able to maintain a state of being coupled to the lower cover 31 via the couple part even after being removed from the opening 31c.

When the opening 31c is opened by removing the lid 31d from the opening 31c, the tool 35 can be inserted into the accommodation space 3a in the lower cover 31 from the outside through the opening 31c. When the tool 35 is inserted into the lower cover 31, the fit part 71a8 of the operation part 71a4 of the first lock portion 71 is fitted to the tip of the tool 35. When the tool 35 is rotated from this state to perform an operation (lock operation and unlock operation) of applying a predetermined or greater rotational torque to the operation part 71a4, the operation part 71a4 of the first lock portion 71 rotates. When the operation part 71a4 rotates, the hook part 71a2 and the couple part 71a3 integrally pivot (pivot operation).

To shift from the unlock state in which the engagement between the engaging parts 71a and 72a and the engaged parts 71b and 72b is released to the lock state in which the engaging parts 71a and 72a and the engaged parts 71b and 72b are engaged, a lock operation of rotating the tool 35 in a predetermined direction (counterclockwise in the example of FIG. 5) is performed. In this case, when the hook part 71a2 pivots, the engagement surface 71a5 of the hook part 71a2 is engaged with the engaged part 71b, and further pivots to lock the lock convex part 71a6 with the engaged part 71b, the engaging part 71a is fixed to the engaged part 71b in a state of being engaged with the engaged part 71b, and the first lock portion 71 is brought into the lock state (solid line in FIG. 5). When the couple part 71a3 pivots, the engaging part 72a (hook part 72a2) of the second lock portion 72 pivots via the interlocking mechanism 73. Then, similarly to the engaging part 71a, when the hook part 72a2 pivots, an engagement surface 72a5 of the hook part 72a2 is engaged with the engaged part 72b, and further pivots to lock a lock convex part 72a6 with the engaged part 72b, the engaging part 72a is fixed to the engaged part 72b in a state of being engaged with the engaged part 72b, and the second lock portion 72 is brought into the lock state (solid line in FIG. 5).

When the engagement between the engaging parts 71a and 72a and the engaged parts 71b and 72b is released to shift to the unlock state, an unlock operation of rotating the tool 35 fitted to the fit part 71a8 in the opposite direction (clockwise in the example of FIG. 5) to the above-described direction is performed. In this case, locking between the lock convex parts 71a6 and 72a6 and the engaged parts 71b and 72b is released, and the engaging parts 71a and 72a are brought into an unlock state of not being fixed to the engaged parts 71b and 72b (broken lines in FIG. 5).

According to the present embodiment, the following operations and effects can be achieved.
(1) The outboard motor 1 includes the engine 2 and the accommodation cover 3 forming the accommodation space 3a that accommodates the engine 2. The accommodation cover 3 includes the lower cover 31 that accommodates the lower part of the engine 2, the upper cover 32 that is attached to the lower cover 31 and accommodates the upper part of the engine 2, and the plurality of lock portions 7 that are provided in the connection part 33 between the lower cover 31 and the upper cover 32 facing the accommodation space 3a and fix the upper cover 32 to the lower cover 31. At least a part of the plurality of lock portions 7 have the interlocking mechanism 73 that simultaneously locks or unlocks at least a part of the plurality of lock portions 7 in response to a single operation.

Since this configuration allows the plurality of lock portions 7 to be simultaneously locked and unlocked by a single lock operation and unlock operation (FIGS. 5 and 6), even when the plurality of lock portions 7 are provided inside the accommodation cover 3, it is possible to reduce the number of man-hours when the upper cover 32 is attached and removed at the time of maintenance or adjustment of the engine 2. The influence on the appearance design of the outboard motor 1 can be reduced by providing the plurality of lock portions 7 inside the accommodation cover 3, and the lock state of the upper cover 32 can be firmly retained by providing the plurality of lock portions 7.
(2) The accommodation cover 3 is provided with the opening 31c. The plurality of lock portions 7 include the first lock portion 71 and the second lock portion 72. The first lock portion 71 includes the operation part 71a4 on which a single operation is performed by the tool 35 inserted into the accommodation space 3a from the outside through the opening 31c. The interlocking mechanism 73 includes the transmission arm 73a that transmits a single operation to the second lock portion 72. The outboard motor 1 is configured to be attachable to the rear of the vessel 100. The first lock portion 71 is provided on the front side relative to the second lock portion 72.

With this configuration, since the opening 31c into which the tool 35 is inserted is only required to be provided at a position opposing the operation part 71a4 of the first lock portion 71, it is possible to reduce the influence on the appearance design of the lower cover 31 (FIG. 2). In particular, since the first lock portion 71 is provided on the front side of the second lock portion 72, the influence on the appearance design of the rear side of the accommodation cover 3 can be reduced (FIG. 3).

(3) Each of the plurality of lock portions 7 includes the engaged part 71b provided in the upper cover 32 and the engaging part 71a provided in the lower cover 31 and configured to be engageable with or disengageable from the engaged part 71b in response to the pivot operation. The interlocking mechanism 73 is connected to the engaging part 71a (FIGS. 3, 5, and 6).

As described above, by attaching the engaged part 71b, which has a fewer number of components and is lighter in weight than the engaging part 71a, to the upper cover 32, it is possible to reduce the weight of the upper cover 32 than that when the engaging part 71a is attached to the upper cover 32. Since the weight of the upper cover 32 is reduced, the upper cover 32 can be easily attached and removed.
(4) The plurality of lock portions 7 are provided along the connection part 33. Among the plurality of lock portions 7, the number of lock portions 7 provided on the left side of the outboard motor 1 is different from the number of lock portions 7 provided on the right side of the outboard motor 1. In the examples of FIGS. 2 and 3, since the shift device 52 is disposed near the connection part on the starboard front side, the independent lock portion 70 is disposed only on the port front side, and the number of lock portions 7 is larger in the port side is larger than that in the starboard side. Thus, by disposing the independent lock portion 70 at a place (the front side in FIG. 3) where the length along the connection part 33 where the first lock portion 71 and the second lock portion 72 are not disposed is relatively long, it is possible to prevent generation of a gap or the like at such a place.
(5) The plurality of lock portions 7 are provided along the connection part 33. Among the plurality of lock portions 7, the number of lock portions 7 provided on the rear side of the outboard motor 1 is larger than the number of lock portions 7 provided on the front side of the outboard motor 1 (FIG. 3). With this configuration, even when a load larger than that on the front side is generated on the rear side of the accommodation cover 3 when the outboard motor 1 is tilted up, it is possible to prevent the upper cover 32 from being removed from the lower cover 31 or a gap or the like from being generated in the connection part 33.
(6) The plurality of lock portions 7 include the independent lock portion 70 that is provided in the connection part 33 between the lower cover 31 and the upper cover 32 independently of the interlocking mechanism 73, and is independently locked or unlocked. With this configuration, by providing the independent lock portion 70, which does not interlock, at an appropriate place, it is possible to appropriately disperse the load generated in the connection part 33. For example, by disposing the independent lock portion 70 at a place where the length along the connection part 33 where the first lock portion 71 and the second lock portion 72 are not disposed is relatively long, it is possible to shorten the distance along the connection part 33 where the lock portion 7 is not disposed.
(7) The vessel 100 includes the outboard motor 1 and the hull 101 to which the outboard motor 1 is attached (FIG. 1). With this configuration, even in the outboard motor 1 equipped on the vessel 100, it is possible to firmly retain the lock state of the upper cover 32 without increasing the number of man-hours when the upper cover 32 is attached and removed at the time of maintenance and adjustment of the engine 2.

The above embodiment can be modified into various forms. Hereinafter, modifications will be described.

In the above embodiment, the independent lock portion 70 on the port front side, the first lock portion 71 and the second lock portion 72 on the starboard rear side, and the first lock portion 71 and the second lock portion 72 on the port rear side have been described as the plurality of lock portions 7, but the present invention is not limited to this. The plurality of lock portions 7 may be configured only by the first lock portion 71 and the second lock portion 72. For example, the plurality of lock portions 7 may be configured by the first lock portion 71 and the second lock portion 72 disposed front and rear on the port side, and the first lock portion 71 and the second lock portion 72 disposed front and rear on the starboard side. The arrangement positions of the plurality of lock portions 7 may be asymmetric between the port side and the starboard side.

The number of lock portions 7 is not limited to this. The plurality of lock portions 7 may be constituted by a set of the first lock portion 71 and the second lock portion 72 depending on the arrangement of each of the first lock portion 71 and the second lock portion 72. For example, the first lock portion 71 may be disposed on the port side, the second lock portion 72 may be disposed on the starboard side, and these may be interlocked by the interlocking mechanism 73.

In the above embodiment, the engaging part 71a is pivotally attached to the inner surface side of the lower cover 31 near the connection part 33, and the engaged part 71b is fixed to the inner surface side of the upper cover 32 near the connection part 33, but the configuration may be reversed. That is, the engaging part 71a may be pivotally attached to the inner surface side of the upper cover 32 near the connection part 33, and the engaged part 71b may be fixed to the inner surface side of the lower cover 31 near the connection part 33.

The above embodiment can be combined as desired with one or more of the aforesaid modifications. The modifications can also be combined with one another.

According to the present invention, it is possible to easily fix the upper cover to the lower cover while suppressing the influence on the appearance of the outboard motor and the risk of breakage.

Above, while the present invention has been described with reference to the preferred embodiments thereof, it will be understood, by those skilled in the art, that various changes and modifications may be made thereto without departing from the scope of the appended claims.

1. An outboard motor, comprising:
an engine; and
an accommodation cover forming an accommodation space accommodating the engine, wherein
the accommodation cover includes:
a lower cover configured to accommodate a lower part of the engine;
an upper cover attached to the lower cover and configured to accommodate an upper part of the engine; and
a plurality of lock portions provided in a connection part between the lower cover and the upper cover facing the accommodation space and configured to fix the upper cover to the lower cover, wherein
a part of the plurality of lock portions includes an interlocking mechanism configured to lock or unlock the part of the plurality of lock portions simultaneously in response to a single operation.

2. The outboard motor according to claim 1, wherein
the accommodation cover is provided with an opening, wherein
the plurality of lock portions includes a first lock portion and a second lock portion, wherein
the first lock portion includes an operation part on which the single operation is performed with a tool inserted into of the accommodation space from outside of the accommodation space through the opening, wherein
the interlocking mechanism includes a transmission part configured to transmit the single operation to the second lock portion, wherein
the outboard motor is configured to be attachable to a rear part of a vessel, wherein
the first lock portion is provided on a front side relative to the second lock portion.

3. The outboard motor according to claim 1, wherein
each of the plurality of lock portions includes:
an engaged part provided in the upper cover; and
an engaging part provided in the lower cover and configured to be engageable with or disengageable from the engaged part in response to an pivot operation of the engaging part, wherein
the interlocking mechanism is connected to the engaging part.

4. The outboard motor according to claim 1, wherein
the plurality of lock portions are provided along the connection part, wherein
among the plurality of lock portions, a number of lock portions provided on a left side of the outboard motor is different from a number of lock portions provided on a right side of the outboard motor.

5. The outboard motor according to claim 1, wherein
the plurality of lock portions are provided along the connection part, wherein
among the plurality of lock portions, a number of lock portions provided on a rear side of the outboard motor is larger than a number of lock portions provided on a front side of the outboard motor.

6. The outboard motor according to claim 1, wherein
the plurality of lock portions includes:
an independent lock portion provided in the connection part between the lower cover and the upper cover independently of the interlocking mechanism and configured to independently locked or unlocked.

7. A vessel, comprising:
an outboard motor according to claim 1; and
a hull to which the outboard motor is attached.
